(19) United States
(12) Patent Application Publication
(10) Pub. No.: US 2025/0084254 A1
(43) Pub. Date: Mar. 13, 2025

(54) COATINGS WITH HIGH OFF-SPECULAR LiDAR REFLECTIVITY AND HIGH LIGHTNESS FLOP

(71) Applicant: BASF COATINGS GMBH, Muenster (DE)

(72) Inventors: Manoj KAYARKATTE, Mangalore (IN); Rajkumar A. JANA, Mangalore (IN); Qingling ZHANG, Southfield, MI (US); Donald H. CAMPBELL, Hartland, MI (US)

(21) Appl. No.: 18/294,031

(22) PCT Filed: Aug. 30, 2022
(86) PCT No.: PCT/EP2022/074114

§ 371 Date: Jan. 31, 2024

(30) Foreign Application Priority Data
Sep. 2, 2021 (IN) 202141039874
May 16, 2022 (EP) 22173577.2

(51) Int. Cl. C09D 5/33; C08K 3/013; C09D 7/61; C09D 201/00; G01S 17/931

(52) U.S. Cl. CPC C09D 5/004; C08K 3/013; C09D 7/61; C09D 201/00; G01S 17/931

(57) ABSTRACT

Disclosed herein is a basecoat composition, including (A) at least one film-forming polymer (A1), and if (A1) is externally crosslinkable, at least one crosslinking agent (A2); (B) at least one type of metal effect pigment (B); (C) a pigment mixture (C), including at least one non-carbon-black LiDAR reflecting pigment (C1) and at least one white LiDAR reflecting pigment (C2) and water and/or one or more organic solvents as component (D). Further disclosed herein are a method of forming a coating film using the basecoat composition, the obtained coating film, an at least partially coated substrate, and a method of using the coating in LiDAR applications.

The present invention relates to basecoat compositions comprising metal effect pigments and near infrared-reflective pigment blends. The invention further relates to a method of forming a coating film making use of the basecoat composition, the thus obtained coating film and an at least partially coated substrate as well as the use of the coatings in LiDAR applications.

### BACKGROUND OF THE INVENTION

Recent advances have been made in technologies related to self-driving vehicles and vehicles with ADAS (Advanced Driver Assistance Systems). Vehicles with ADAS decrease driving stress, decrease the number of accidents, improve fuel economy etc.

Typically, such technologies require the detection of objects in a vehicle's surroundings. Detecting systems generally comprise sensors, cameras, radar, ultrasonic, and lasers to detect and locate obstacles such that the vehicle can safely navigate around such objects. Some detecting systems are limited in their ability to detect objects at long distances or non-ideal environments, such as in low-light conditions, in inclement weather, such as fog, rain, and snow, or in other conditions with light scattering particulates in the air (e.g., smog and dust). Such limitations may prohibit the vehicles from safely navigating obstacles.

ADAS rely highly rely on remote sensing technologies on optical or electromagnetic means for position and speed determination.

LiDAR (Light Detection And Ranging) is a remote-sensing technology that can be deployed within such vehicles as the primary source of object recognition. By illuminating the surrounding environment with Laser light (typically 905 nm or 1550 nm) LiDAR maps distance to objects in its path in real-time and can be paired with software to safely react to objects within their vicinity. For example, if an object gets too close to the vehicle, the software can react to avoid collision with the object. Since LiDAR utilizes near-infrared light (near-IR light or NIR light) as its source of illumination, the technology has to overcome several challenges.

Although many light-colored objects reflect this type of light with relative ease, especially dark colored and clear objects either absorb or pass the light, thus lowering the resolution and leading to potential instances, where objects are not sufficiently observed by the LiDAR and avoided by vehicles equipped with such systems.

This shows that apart from the LiDAR instrument, one of the important factors for the accuracy of the measurement is the surface of the illuminated object. In case of the automobiles and other vehicles, the surface is usually covered by a multilayer coating, which plays an important role in determining the LiDAR reflectivity.

An object's ability to reflect light is dependent on its bulk and surface properties, and manifests itself as specular or diffuse. Specular reflection of light occurs when incident light stemming from a light source in a single direction is reflected into a single outgoing direction at the opposite angle to the plane normal to the reflective surface as the incident wave. Diffuse reflection occurs when incident light stemming from a light source in a single direction is reflected at many angles. In theory, both specular and diffuse reflection can be utilized in LiDAR technology for vehicles, but in practice, this is much more difficult. With specular reflection, much of the luminance is observed at the angle opposite the angle of incidence. Thus, for a moving vehicle with a detector positioned at the light source, this could prove problematic if the angle of incidence was positioned away from the tandem light source and detector. Such is the case when the angle of incidence is 45 degrees or higher from the plane normal to the reflective surface. In contrast, diffuse reflection demonstrates equivalent luminance from all directions, which can alleviate this concern, and allows detection at all angles.

Still, most of the current coatings are applied to substrates such as vehicle bodies for improved durability and aesthetics, but usually impart no sufficient functionality in reflecting near-IR light for the purposes of greater visibility to LiDAR technology.

In recent years a few approaches were developed to improve the LiDAR reflectivity of multilayer coatings, particularly those applied to vehicles. To understand the approaches, one needs to consider the typical architecture of automotive multilayer coatings. The coating layers on vehicle bodies and parts thereof, starting from the substrate are typically a conversion coating layer, an electrodeposition coating layer, such as preferably a cathodic electrodeposition layer, a primer layer (also called filler layer), a basecoat layer, and on top of the basecoat layer a clearcoat layer as top coat. The afore-mentioned primer layer, basecoat layer and clearcoat layer are often referred to as tricoat.

In a first approach, NIR-reflective pigments are contained in the basecoat layer. The NIR light passes the non-NIR-absorbing protective clearcoat layer and is reflected by the NIR-reflective pigment(s) in the basecoat layers. In a different, second approach, the NIR light passes the non-NIR-absorbing protective clearcoat layer and the basecoat layer which may contain non-NIR-absorbing coloring pigments, but is reflected by the subjacent primer layer or substrate, if no primer layer is present.

While both approaches work well for solid color multilayer coatings, problems arise when metal effect pigments are contained in the basecoat layer to provide the multilayer coating with so-called lightness flop effect, particularly, if the lightness flop is to be provided in form of a silver-metallic multilayer coating. The term “lightness flop” (or just flop as used herein) refers to the difference between the amount or hue of light reflected at different angles from a metallic coating surface. The flop depends on particle size and distribution, particle shape and orientation of the effect pigment particles in the coating layer. The extend of the flop effect can be expressed by the so-called flop index, which is a measure of change in reflectance of a metallic coating containing platelet-shaped pigments as it is rotated through the range of viewing angles. A flop index of 0 indicates a solid color, while a very high flop may even result in a flop index of above 15.

Generally, the larger platelet-shaped particles are better reflectors leading to higher flop index and brightness, while smaller particles show less flop as the amount of light scattered at edges increases as a nondirectional reflection. With even coarser metallic pigments, the individual particles become more visible, leading to graininess or texture.

Thus, although the most desired platelet-shaped metallic pigments are typically highly reflective and coatings obtained by using such pigments typically possess a high flop index, they also possess a very specular reflectivity and therefore have low reflectivity in the off-specular angle range, which adversely affects the LiDAR reflectivity from those vehicles which are not directly in front of the light source/detector system, but at an angle or in adjacent lane thereto.

Consequently, coatings obtained by use of conventional metallic pigment containing coating compositions show a rather high flop index of 9 and above, while their LiDAR reflectivity at an angle of incidence of 45° is typically below 9% or even much lower such as below 5%. Generally, the higher the flop the lower the LiDAR reflectivity.

Therefore, the present invention aims preserve the lightness flop at a level being about the same as for conventional silver-metallic coatings, while improving the visibility of thus coated objects to LiDAR detection. This should be reached by providing a basecoat composition comprising platelet-shaped metallic pigments to achieve a high flop index of the therewith obtained coating and which should further contain ingredients which have no or only a small effect on the flop index, but which are apt to equip the coating layer formed from the coating composition with a significantly increased LiDAR reflection. Furthermore, the ingredients to be added to the conventional silver-metallic basecoat composition should have a rather low hiding power to allow an excellent appearance of the multilayer coating comprising such basecoat layer, such appearance including the color effect provided by the primer layer of such multilayer coating.

### SUMMARY

The above aim is achieved by providing a basecoat composition, comprising
(A) at least one film-forming polymer (A1), and in case of (A1) being externally crosslinkable, at least one crosslinking agent (A2);
(B) at least one type of metal effect pigment (B);
(C) a pigment mixture (C), comprising
   at least one non-carbon-black LiDAR reflecting pigment (C1) or combination of non-carbon-black LiDAR reflecting pigments (C1), the pigment or combination of pigments having a masstone color with full hiding according to CIELAB system at 45° the values of L*<17, a*>−4 and <9, and b*>−4 and <9, and
   at least one white LiDAR reflecting pigment (C2) or combination of white LiDAR reflecting pigments (C2), the pigment or combination of pigments having a masstone color with full hiding according to CIELAB system 45° the values of L*>85, a*>−2 and <2, and b*>0 and <6, (C2);
(D) water and/or one or more organic solvents as component (D),
   wherein
   (C1) is present in a range from 0.005 to 2.0 wt.-% based on the total weight of the composition, and
   (C2) is present in a range from 0.20 to 10.0 wt.-% based on the total weight of the composition.

As used herein, a pigment is considered to be a LiDAR reflecting pigment, if it shows a LiDAR reflectivity of at least 15% at an angle of incidence of 0°, LiDAR reflectivity of at least 8.5% at an angle of incidence of 45°, and LiDAR reflectivity of at least 6% at an angle of incidence of 60°. All LiDAR measurements are also carried out as described in the method section of this invention.

The term “masstone color with full hiding” is used and understood as it is commonly used and understood in colorimetry. The “masstone color” is defined as the color which is obtained by applying a coating layer containing the respective pigment to completely cover a black and a white substrate (typically a so-called “checker tile” being partially black and partially white is used) in a layer thickness, where no black and white color information shines through. The respective layer thickness is obtained by repeatedly spraying the coating composition until the colorimetric data for L*, a* and b* are the same for the coated black and white parts of the substrate, respectively, thus guaranteeing that no substrate color specific information confounds the pigment specific values. More details are disclosed in the method section of this invention.

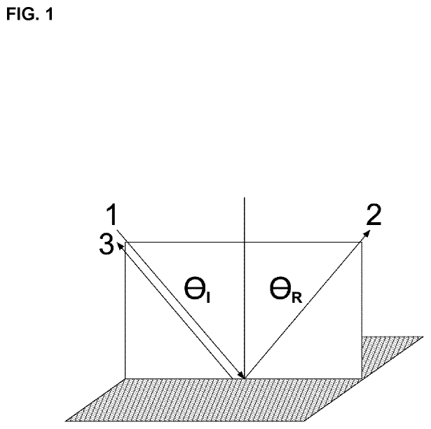

To facilitate the understanding of LiDAR reflection, angle of incidence and other terms used herein, it is referred to FIG. 1, wherein 1 and Θ_{I} stand for the transmitter and the angle of incidence, 2 and Θ_{R} stand for specular reflection and the reflection angle and 3 for the receiver (opposition angle).

Further object of the present invention is a method of forming a coating layer at least partially onto at least one surface of a substrate, wherein said method comprises at least step (a), namely
(a) applying the inventive basecoat composition according to any one of the preceding claims at least partially onto at least one surface of an optionally pre-coated substrate to form a coating layer on the surface of the substrate.

Yet another object of the present invention is a coating layer obtainable from the coating composition according to the invention or by the method according to the present invention.

Further object of the invention is an at least partially coated substrate obtainable by the method according to the invention.

Another object of the invention is the use of the inventive coating composition in LiDAR visibility applications, in particular for autonomous systems such as self-driving vehicles and vehicles with ADAS.

### DETAILED DESCRIPTION

### Basecoat Composition

The inventive basecoat composition (herein also referred to as inventive coating composition), can be a solvent-based basecoat composition (in the following also referred to as solvent-borne basecoat composition) or an aqueous basecoat composition (in the following also referred to as waterborne basecoat composition). Preferably the coating composition is an aqueous basecoat composition. Preferably, the coating composition is used as a one-pack solvent-borne or waterborne basecoat composition. The inventive coating composition is in particular not a primer, primer surfacer or sealer composition and is thus not to be used/applied as a primer, primer surfacer or sealer composition.

The coating composition according to the invention is preferably suitable for producing a basecoat layer. The coating composition according to the invention is therefore particularly a solvent-borne basecoat material or an aqueous basecoat material.

The term “basecoat” is known in the art and, for example, defined in Römpp Lexikon, “Lacke und Druckfarben” (“Paints and “Printing Inks”), Georg Thieme Verlag, 1998, 10th edition, page 57. A basecoat is therefore in particular used in automotive coating and general industrial paint coloring in order to give a coloring and/or an optical effect by using the basecoat as an intermediate coating composition. Basecoat compositions are generally applied to a metal or plastic substrate, optionally pretreated and/or precoated with a primer and/or filler, sometimes in the case of plastic substrates it might also be applied directly on the plastic substrate, and in the case of metal substrates on an electrodeposition coating layer coated onto the metal substrate or on the metal substrate already bearing a primer and/or filler and/or electrodeposition coating, or to already existing coatings in case of refinish applications, which can also serve as substrates. In order to protect a basecoat layer in particular against environmental influences, at least one additional clearcoat layer is applied to it.

The term “comprising” in the general context of the present invention and particularly in connection with the coating composition according to the invention has the meaning of “containing” rather than “consisting of”. Particularly, “comprising” means that in addition to the components (A1), (A2), (B), (C) and (D) one or more of the other components mentioned hereinafter may optionally be contained in the coating composition according to the invention. All components can be present in each case in accordance with their preferred embodiments mentioned below.

The proportions and amounts in wt.-% (i.e., % by weight) of all components (A1), (A2), (B), (C) and (D) and further optionally present components in the coating composition according to the invention add up to 100 wt.-%, based on the total weight of the coating composition.

As used herein, the term “near-IR” or “near-infrared radiation or light” or “NIR” refers to electromagnetic radiation in the near-infrared range of the electromagnetic spectrum. Such near-IR electromagnetic radiation may have a wavelength from 800 nm to 2500 nm, such as from 850 to 2000 nm or such as from 900 nm to 1600 nm. In particular, the NIR light used has a wavelength from 880 nm to 930 nm with 905 nm as center wavelength. The near-IR electromagnetic radiation source that may be used in the present invention to produce NIR light includes, without limitation, light emitting diodes (LEDs), laser diodes or any light source that is capable of emitting electromagnetic radiation having a wavelength from 800 nm to 2500 nm (in the near-IR range). The near-IR electromagnetic radiation source may be used in a LiDAR (Light Detection and Ranging) system. The LiDAR system may utilize lasers to generate electromagnetic radiation with a wavelength from 900 nm to 1600 nm.

Preferably, the coating layer obtained from the coating composition of the present invention is able to reflect NIR light, preferably NIR light having a wavelength from 800 to 2500 nm.

Besides the components (B) and (C) the basecoat compositions of the present invention may contain one or more pearlescent pigments as component (E). However, preferably, the inventive coating composition does not contain any further pigments, particularly the inventive basecoat composition does not include further solid color pigments.

Preferably, the inventive coating composition does not contain any further components that are fillers. Thus, the inventive coating composition is preferably filler-free. In case any components are contained in the coating composition, that are pigments and/or fillers other than (B), (C) and (E), these components preferably do not or preferably do substantially not absorb any light. Herein, thickeners, i.e., thickening agents are not considered to be subsumed under the term “pigments and/or fillers”.

The solids content of the coating composition according to the invention is preferably >85% or >60% or >40% or >5% by weight, in each case based on the total weight of the coating composition. The determination of the solids content, i.e., the non-volatile content, is carried out according to the method described hereinafter in the method section of the present invention. Preferably, the solids content of the coating composition according to the invention is in a range from 5 to 85 wt.-%, more preferably from >10 to 80 wt.-%, most preferably from >15 to 75 wt.-%, in particular from >20 to 65 wt. %.

### Film-Forming Polymer (A1)

The inventive coating composition comprises at least one film-forming polymer as film-forming binder (A1) of the coating composition.

For the purposes of the present invention, the term (A1) is understood to be the non-volatile constituent of a coating composition, which is responsible for the film formation, excluding additives, particularly excluding additives (E). Preferably, at least one polymer of the at least one polymer (A1) is the main binder of the coating composition. As the main binder in the present invention, a binder component is preferably referred to, when there is no other binder component in the coating composition, which is present in a higher proportion based on the total weight of the coating composition.

The term “polymer” is known to the person skilled in the art and, for the purposes of the present invention, encompasses polyadducts and polymerizates as well as polycondensates. The term “polymer” includes both homopolymers and copolymers.

The at least one polymer used as component (A1) may be physically drying, self-crosslinkable or externally crosslinkable. Suitable polymers which can be used as component (A1) are, for example, described in EP 0 228 003 A1, DE 44 38 504 A1, EP 0 593 454 B1, DE 199 48 004 A1, EP 0 787 159 B1, DE 40 09 858 A1, DE 44 37 535 A1, WO 92/15405 A1 and WO 2005/021168 A1.

The at least one polymer used as component (A1) is preferably selected from the group consisting of polyurethanes, polyureas, polyesters, polyamides, poly(meth)acrylates and/or copolymers of the structural units of said polymers, in particular polyurethane-poly(meth)acrylates and/or polyurethane polyureas. The at least one polymer used as component (A1) is particularly preferably selected from the group consisting of polyurethanes, polyesters, poly(meth)acrylates and/or copolymers of the structural units of said polymers. The term “(meth) acryl” or “(meth) acrylate” in the context of the present invention in each case comprises the meanings “methacrylic” and/or “acrylic” or “methacrylate” and/or “acrylate”.

Preferred polyurethanes are described, for example, in German patent application DE 199 48 004 A1, page 4, line 19 to page 11, line 29 (polyurethane prepolymer B1), in European patent application EP 0 228 003 A1, page 3, line 24 to page 5, Line 40, European Patent Application EP 0 634 431 A1, page 3, line 38 to page 8, line 9, and international patent application WO 92/15405, page 2, line 35 to page 10, line 32.

Preferred polyesters are described, for example, in DE 4009858 A1 in column 6, line 53 to column 7, line 61 and column 10, line 24 to column 13, line 3 or WO 2014/033135 A2, page 2, line 24 to page 7, line 10 and page 28, line 13 to page 29, line 13 described. Likewise, polyesters may have a dendritic structure, as described, for example, in WO 2008/148555 A1.

Preferred polyurethane-poly(meth)acrylate copolymers (e.g., (meth)acrylated polyurethanes)) and their preparation are described, for example, in WO 91/15528 A1, page 3, line 21 to page 20, line 33 and in DE 4437535 A1, page 2, line 27 to page 6, line 22 described.

Preferred poly(meth) acrylates are those which can be prepared by multistage free-radical emulsion polymerization of olefinically unsaturated monomers in water and/or organic solvents. For example, seed-core-shell polymers (SCS polymers) are particularly preferred. Such polymers or aqueous dispersions containing such polymers are known, for example, from WO 2016/116299 A1.

Preferred polyurethane-polyurea copolymers are polyurethane-polyurea particles, preferably those having an average particle size of 40 to 2000 nm, the polyurethane-polyurea particles, each in reacted form, containing at least one isocyanate group-containing polyurethane prepolymer containing anionic and/or groups which can be converted into anionic groups and at least one polyamine containing two primary amino groups and one or two secondary amino groups. Preferably, such copolymers are used in the form of an aqueous dispersion. Such polymers can in principle be prepared by conventional polyaddition of, for example, polyisocyanates with polyols and polyamines.

The polymer used as component (A1) preferably has reactive functional groups which enable a crosslinking reaction. Any common crosslinkable reactive functional group known to those skilled in the art can be present. Preferably, the polymer used as component (A1) has at least one kind of functional reactive groups selected from the group consisting of primary amino groups, secondary amino groups, hydroxyl groups, thiol groups, carboxyl groups and carbamate groups. Preferably, the polymer used as component (A1) has functional hydroxyl groups.

Preferably, the polymer used as component (A1) is hydroxy-functional and more preferably has an OH number in the range of 10 to 500 mg KOH/g, more preferably from 40 to 200 mg KOH/g.

The polymer used as component (A1) is particularly preferably a hydroxy-functional polyurethane-poly(meth)acrylate copolymer, a hydroxy-functional polyester and/or a hydroxy-functional polyurethane-polyurea copolymer.

In addition, the coating composition of the present invention may contain at least one typical crosslinking agent known per se. Crosslinking agents are to be included among the film-forming non-volatile components of a coating composition, and therefore fall within the general definition of the “binder”. Crosslinking agents are thus to be subsumed under the component (A).

### Crosslinking Agent (A2)

If (A1) is externally crosslinkable, a crosslinking agent (A2) is needed for crosslinking, which preferably is at least one aminoplast resin and/or at least one blocked or free, preferably blocked polyisocyanate, and most preferably an aminoplast resin. Among the aminoplast resins, melamine resins such as melamine-formaldehyde resins are particularly preferred.

### Metal Effect Pigment (B)

The term “metal effect pigment” is used in accordance with EN ISO 18451-1:2019 (Pigments, dyestuffs and extenders—Terminology—Part 1). They are defined as platelet-shaped pigments consisting of metal. In the present invention the term “consisting of metal” does not exclude surface modifications of the metal effect pigments such as the presence of additional oxide layers, as e.g., a silicon dioxide layer. The term “metal” as used in the term “metal effect pigments” includes metals and metal alloys, likewise. Metal effect pigments—as already lined out above—can be orientated in parallel and show then metallic gloss due to light reflection at the flakes.

Typical metals and alloys used in metal effect pigments are aluminum, and its alloys. Most suitable and preferred in the present invention are platelet-shaped aluminum effect pigments, which might be coated or uncoated and which are preferably coated, particularly in case of the preferred aluminum pigments to inhibit their reaction with water in aqueous basecoat compositions. Such inhibition can e.g., be achieved by the use of organo-phosphorous stabilization; passivating the aluminum pigments with a conversion layer, e.g., by chromating; encapsulation with a protective layer, such as a polymer coating or a silica coating (Peter Wißling, “Metallic Effect Pigments”, Vincentz Network 2006, pp. 85-89). Such aluminum effect pigments are e.g., commercially available from ECKART GmbH (Germany) under the tradenames STAPA® Hydroxal (stabilized), STAPA® Hydrolux (chromated) and STAPA® Hydrolan (silica encapsulated). Further modification of the pigment surfaces is also possible, e.g., by modification with non-polar groups, such as alkyl groups leading to a so-called semi-leafing effect.

The metal effect pigments, particularly aluminum effect pigments, may be coated with an oxide layer, such as a silica layer, which further helps to stabilize the pigments against mechanical impact und particularly improves circulation line stability. In the present invention silica encapsulated aluminum metal effect pigments are most preferred. Preferably, the amount of silica, based on the sum of the amounts of aluminum and silica in such preferred aluminum effect pigments ranges from 3 to 15 wt.-% more preferred from 5 to 12 wt.-% and most preferred from 6 to 10 wt.-%. However, the term “metal effect pigment” encompasses such coated pigments and the total weight of such coated metal effect pigment is understood to be the weight of the metal effect pigment. Thus, the weight includes the coating material.

The amount of (B) in the basecoat composition of the present invention is preferably in the range from 0.5 to 10 wt.-%, more preferred in the range from 1 to 8 wt.-% and most preferred in the range from 1.5 to 6 wt.-%, based on the total weight of the coating composition.

The weight ratio of (B)/[(A1)+(A2)] in the coating compositions of the present invention is preferably in the range from 0.02 to 1.0, more preferred in the range from 0.05 to 0.5 and most preferred in the range from 0.1 to 0.35.

Preferably, the platelet-shaped pigments have a D50 value, i.e., median particle size, in the range from 5 μm to 100 μm and even more preferred in the range from 15 μm to 30 μm as determined by laser granulometry according to ISO 13320-1 (determined with a CILAS 1064 instrument).

The metal effect pigments are preferably employed in the coating compositions of the present invention in form of pigment pastes, such pigment pastes preferably contain 40 to 70 wt.-%, more preferably 50 to 65 wt.-% of the metal effect pigments based on the total weight of the pastes. The volatile part is typically an organic solvent such as an alcohol, preferably isopropanol. The pastes may further contain minor amounts of lubricants and other additives.

### Pigment Mixture (C)

The pigment mixture to be used in the basecoat compositions of the present invention consist of a dark non-carbon black LiDAR reflecting pigment (C1) and a white LiDAR reflecting pigment (C2).

The color of the dark non-carbon black pigment (C1) and the color of the white pigment (C2) can be defined using the CIELAB system, measuring the values for L*, a* and b* with a BYK Mac I instrument (from Byk Gardner) following ASTM D 2244, E308, E1164 and E2194.

The color of the dark non-carbon black pigment (C1) is characterized according to CIELAB system at 45°, in that the L* value is less than 17, more preferred less than 15 and in that the a* and b* values are more than −4 and less than 9, more preferred less than 6 and most preferred less than 4 and preferably more than 0.

Preferred dark non-carbon black pigments (C1) can be organic or inorganic, the inorganic pigments being preferred and being selected from the group consisting of iron/chromium oxide compounds such as iron/chromium oxide complexes, as iron/chromium oxide green-black, as iron/chromium oxide brown-black. Manganese ferrite black oxide, calcium manganese titanium oxide and chromium-free compounds.

Commercially available dark non-carbon black pigments (C1) are e.g., selected from Sicopal Black K0095 and L0095 (from BASF), 10P950, 10P922, 10G996 (all three from Shepherd), Nubifer NB 803K and Eclipse Black 10202 (both from Ferro) and Tipaque Black SG103 (from Ishihara).

The color of the white pigment (C2) is also characterized according to CIELAB system at 45°, in that the L* value is more than 85, preferably more than 90, the a* value is more than −2 and less than 2, preferably less than 0 and the b* value is less than 6 and preferably more than 0, more preferred more than 2 or 3.

Preferred white pigments (C2) are selected from the group consisting of titanium/aluminum/silicon oxide-based pigments and rod-like aluminum-doped titanium dioxide pigments. A rod-like pigment preferably has a long dimension of 1 to 5 such as 2 to 4 μm and a hart dimension of 0.2 to 0.6, such as 0.3 to 0.5 μm.

Commercially available white pigments (C2) are e.g., selected from Altiris 550 and Altiris 800 (both from Vanator) and Tipaque PFR404 (from Ishihara).

The pigments (C1) and (C2) preferably have a low hiding power and high scattering power. The low hiding of the pigment decreases flop Index only by a small factor, while the high scattering power increases the LiDAR activity by a higher degree. (C1) is present in a range from 0.005 to 2.0 wt.-%, preferred 0.01 to 1.0 wt.-%, more preferred 0.015 to 0.8 wt.-%, such as 0.02 to 0.5 wt.-% based on the total weight of the composition, and (C2) is present in a range from 0.2 to 10.0 wt.-%, preferably 0.25 to 8.0 wt.-%, more preferred 0.4 to 6.0 wt.-% based on the total weight of the composition.

Generally, the amounts of (C1) and (C2), respectively, are preferably in the lower parts of the afore-mentioned ranges and the lower parts of the preferred, more preferred and most preferred of the afore-mentioned ranges, if the basecoat composition is an aqueous basecoat composition. This is because the aqueous basecoat compositions, compared to solvent-borne basecoat compositions, preferably possess a low total solids content. The lower the total solids content, the lower the binder content and at a low binder content a low pigment content of pigment (C1) and (C2) is preferred.

On the other hand, the amounts of (C1) and (C2), respectively, are preferably in the upper parts of the afore-mentioned ranges and the upper parts of the preferred, more preferred and most preferred of the afore-mentioned ranges, if the basecoat composition is a solvent-borne aqueous basecoat composition. This is because the solvent-borne basecoat compositions, compared to aqueous basecoat compositions, preferably possess a rather high total solids content. The higher the total solids content, the higher the binder content and at a high binder content a high pigment content of pigment (C1) and (C2) is preferred.

The weight ratio of [(C1)+(C2)]/[(A1)+(A2)] in the coating compositions of the present invention is preferably in the range from 0.005 to 0.1, more preferred in the range from 0.01 to 0.075 and most preferred in the range from 0.015 to 0.05.

Preferably the weight ratio of (C2)/(C1) is in the range from 10 to 30, more preferred from 12 to 25, even more preferred 14 to 22.

### Component (D)

The inventive coating composition comprises water and/or one or more organic solvents as component (D), said component (D) being present in the coating composition in an amount which is the difference between the weight of the total weight of the composition and its solids content.

When the inventive coating composition mainly comprises water as a volatile component, it is named an aqueous or waterborne composition. In this case it is preferably a coating composition comprising organic solvents in minor proportions.

All conventional organic solvents known to those skilled in the art can be used as organic solvents for the preparation of the coating composition of the invention. The term “organic solvent” is known to those skilled in the art, in particular from Council Directive 1999/13/EC of 11 Mar. 1999. Preferably, the one or more organic solvents are selected from the group consisting of monohydric or polyhydric alcohols, for example, methanol, ethanol, 1-propanol, 2-propanol, 1-butanol, ethylene glycol, ethyl glycol, propyl glycol, butyl glycol, butyl diglycol, 1,2-propanediol and/or 1,3-propanediol; ethers, for example diethylene glycol dimethyl ether; aliphatic hydrocarbons, aromatic hydrocarbons, for example toluene and/or xylenes; ketones, for example acetone, N-methylpyrrolidone, N-ethylpyrrolidone, methyl isobutyl ketone, isophorone, cyclohexanone, methyl ethyl ketone; esters, for example methoxypropyl acetate, ethyl acetate and/or butyl acetate; amides, for example dimethylformamide and mixtures thereof.

### Further Optional Components of the Coating Composition (E)

The inventive coating composition may optionally comprise one or more components, which are different from each of components (A1), (A2), (B), (C) and (D).

The coating composition of the present invention may contain one or more commonly used additives (E) depending on the desired application. For example, the coating composition may comprise at least one additive selected from the group consisting of reactive diluents, such as polypropylene diols, light stabilizers, antioxidants, deaerators, emulsifiers, slip additives, polymerization inhibitors, plasticizers, initiators for free-radical polymerizations, adhesion promoters, flow control agents, film-forming auxiliaries, sag control agents (SCAs), flame retardants, corrosion inhibitors, siccatives, biocides and/or matting agents. They can be used in the known and customary proportions. Preferably, their content, based on the total weight of the coating composition according to the invention is 0.01 to 25 wt.-%, more preferably 0.05 to 20 wt.-%, particularly preferably 0.1 to 15% by weight, most preferably from 0.1 to 10% by weight, especially from 0.1 to 7% by weight and most preferably from 0.1 to 5% by weight.

Amongst the additives, the coating composition according to the invention may optionally contain at least one thickener or rheology agent. Examples of such thickeners are inorganic thickeners, for example metal silicates such as sheet silicates, and organic thickeners, for example poly(meth)acrylic acid thickeners and/or (meth)acrylic acid (meth)acrylate copolymer thickeners, polyurethane thickeners and polymeric waxes. The metal silicate is preferably selected from the group of smectites. The smectites are particularly preferably selected from the group of montmorillonites and hectorites. In particular, the montmorillonites and hectorites are selected from the group consisting of aluminum-magnesium silicates and sodium-magnesium and sodium-magnesium fluorine-lithium phyllosilicates. These inorganic phyllosilicates are marketed, for example, under the trademark Laponite®. Thickeners based on poly(meth) acrylic acid and (meth) acrylic acid (meth) acrylate copolymer thickeners are optionally crosslinked and or neutralized with a suitable base. Examples of such thickening agents are “Alkali Swellable Emulsions” (ASE), and hydrophobically modified variants thereof, the “Hydrophically Modified Alkali Swellable Emulsions” (HASE). Preferably, these thickeners are anionic. Corresponding products such as Rheovis® AS 1130 are commercially available. Polyurethane based thickeners (e.g., polyurethane associative thickeners) are optionally crosslinked and/or neutralized with a suitable base. Corresponding products such as Rheovis® PU 1250 are commercially available. Examples of suitable polymeric waxes are optionally modified polymeric waxes based on ethylene-vinyl acetate copolymers. A corresponding product is commercially available, for example, under the name Aquatix® 8421.

It at least one thickener is present in the coating composition according to the invention, it is preferably present in an amount of at most 10% by weight, more preferably at most 8% by weight, most preferably at most 4% by weight, especially at most 2% by weight. %, most preferably not more than 1% by weight, based in each case on the total weight of the coating composition. The minimum amount of thickener is preferably in each case 0.1% by weight, based on the total weight of the coating composition.

The further optional ingredients (E) may also comprise pearlescent pigments.

The preparation of the coating composition can be carried out using customary and known preparation and mixing methods and mixing units, or using conventional dissolvers and/or stirrers.

### Coating Films and Coatings

A further subject-matter of the present invention is a coating film or a coating, both of which are obtainable from the inventive basecoat composition, in particular by applying the inventive coating composition, preferably according to an inventive method as disclosed below.

All preferred embodiments described above herein in connection with the inventive coating composition and the preferred embodiments thereof are also preferred embodiments of the inventive coating film and the inventive coating.

Preferably, the inventive coating film and the inventive coating are present at least partially on the surface of a substrate, said substrate being not or essentially not NIR-reflective, said substrate being preferably a dark or clear substrate. Dark substrates are in particular substrates bearing a dark colored (multilayer) film, such as a grey primer film. In particular in this case, the dark color can be a result of the use of carbon black pigments in a primer coating layer of the multicoat film.

The inventive coating film and the inventive coating are able to reflect near-infrared (NIR) light having a wavelength from 700 to 1560 nm.

### Inventive Methods

A further subject-matter of the present invention is a method of forming a coating film at least partially onto at least one surface of a substrate, wherein said method comprises at least step (a), namely
(a) applying the inventive basecoat composition at least partially onto at least one surface of an optionally pre-coated substrate to form a coating film on the surface of the substrate.

A further subject-matter of the present invention is a method of forming a coating at least partially onto at least one surface of a substrate, wherein said method comprises at least step (a) as defined above and at least step (b), namely
(b) curing the coating film obtained after performing of step (a) to form a coating on the surface of the substrate.

All preferred embodiments described above herein in connection with the inventive coating composition, the inventive coating film and the inventive coating and the preferred embodiments thereof, are also preferred embodiments of the inventive methods of forming a coating film and a coating.

When the inventive coating composition is a—preferably aqueous—basecoat coating composition, step (a) or steps (a) and (b) is/are preferably carried out onto at least one surface of a pre-coated substrate, if the substrate is a metal substrate. Said metal substrate then preferably bears a primer and/(or) an electrodeposition coating as pre-coating layers and/(or) a conversion coating layer as pre-treatment.

If the substrate is a plastic (polymeric) substrate, it may be a pre-coated substrate, which, e.g., bears a primer coating, but does not have to. Independent of the substrate used, after having performed step (a) or steps (a) and (b), preferably a clearcoat composition is applied onto the basecoat coating formed by making use of the inventive coating composition.

The inventive coating composition can be coated on an object by numerous techniques well-known in the art, including spray coating, drop coating, dip coating, roll coating, curtain coating, and other techniques. Preferably, the inventive coating compositions are applied by spray coating, more preferred by pneumatic or electrostatic spray coating. It can be applied wet-on-wet, but does not have to.

The substrate used can be a plastic substrate, i.e., a polymeric substrate. Preferably, thermoplastic polymers are used as such substrates. Suitable polymers are poly(meth)acrylates including polymethyl(meth)acrylates, polybutyl (meth)acrylates, polyethylene terephthalates, polybutylene terephthalates, polyvinylidene fluorides, polyvinyl chlorides, polyesters, including polycarbonates and polyvinyl acetate, polyamides, polyolefins such as polyethylene, polypropylene, polystyrene, and also polybutadiene, polyacrylonitrile, polyacetal, polyacrylonitrile-ethylene-propylene-diene-styrene copolymers (A-EPDM), ASA (acrylonitrile-styrene-acrylic ester copolymers) and ABS (acrylonitrile-butadiene-styrene copolymers), polyetherimides, phenolic resins, urea resins, melamine resins, alkyd resins, epoxy resins, polyurethanes, including TPU, polyetherketones, polyphenylene sulfides, polyethers, polyvinyl alcohols, and mixtures thereof. Polycarbonates and poly(meth)acrylates are especially preferred. The substrate can also be a composite substrate such as a fiber reinforced substrate containing e.g., glass fibers, carbon fibers or polymeric fibers such as polyamide fibers. The substrate can also consist of multiple polymeric layers.

The substrate used can also be a metal such as steel and aluminum or alloys of these. Further, the substrate used can be glass or textiles, in particular glass.

Preferably, the substrate used is not or essentially not NIR-reflective. More preferably, the substrate is a dark or clear substrate. Dark substrates are in particular substrates such as metals or plastics, for instance polycarbonate, bearing a dark colored multilayer film such as a black colored film. A clear substrate is for example glass or a polycarbonate substrate.

### Substrate

A further subject-matter of the present invention is an at least partially coated substrate obtainable by the inventive method. Preferably, the substrate as such prior to performing the inventive coating method is not or essentially not NIR-reflective, preferably is a dark or clear substrate. Dark substrates are in particular substrates bearing a dark colored (multilayer) film.

All preferred embodiments described above herein in connection with the inventive coating composition, the inventive coating film, the inventive coating, as well as the inventive methods of forming a coating film and a coating, and the preferred embodiments thereof, are also preferred embodiments of the inventive substrate.

The coated substrates can be used to produce, e.g., automotive bodies and parts thereof.

### Use

A further subject-matter of the present invention is a use of the inventive coatings and/or the inventive at least partially coated substrates and/or objects produced from said substrates in LiDAR visibility applications, in particular for autonomous systems such as self-driving vehicles and vehicles with ADAS. Of course, the coating material can also be applied to non-autonomous vehicles and parts thereof to make such vehicles and parts thereof LiDAR reflective for detection by other vehicles, such as autonomous vehicles.

All preferred embodiments described above herein in connection with the inventive coating composition, the inventive coating film, the inventive coating, as well as the inventive methods of forming a coating film and a coating and the inventive partially coated substrate, and the preferred embodiments thereof, are also preferred embodiments of the inventive use.

The inventive use allows a benefit from better infrared light and LiDAR visibility, in particular for autonomous systems such as self-driving vehicles and vehicles with ADAS.

### Experimental Part

### Methods

### 1. Determination of the Solids Content

The amount of solids content (non-volatile matter) including the total solid content is determined via DIN EN ISO 3251:2008-06 at 110° C. for 60 min.

### 2. Determination of the Masstone Color of the Pigment(s) (C1) and (C2)

The “masstone color” is determined as the color which is obtained by applying a coating layer containing the respective pigment to completely cover a black and a white substrate (typically a so-called “checker tile” being partially black and partially white is used) in a layer thickness, where no black and white color information shines through.

The coating composition used to determine the mass tone color for the aim of the present invention is described in Table 1. For each pigment (C1) or (C2), or for each mixture of pigments (C1) or mixture of pigments (C2), a piment paste is prepared by vibroshaking. The ingredients in each pigment paste were: 30 parts by weight of the respective solid pigment (i.e., pigment (C1) or pigment (C2) or mixture of pigments (C1) or mixture of pigments (C2)), 15 parts by weight of water, 2 parts by weight of Butyl-Cellosolve, 39.2 parts by weight of a polyurethane grinding resin, 4.8 parts by weight of Pluracol 1010 Polyol and 9 parts by weight of Byk 184.

The respective layer thickness is obtained by repeatedly spraying the coating composition until the colorimetric data for L*, a* and b* are the same for the coated black and white parts of the substrate, respectively, thus guaranteeing that no substrate color specific information confounds the pigment specific values. Typically, this is achieved at a pigment volume concentration of approx. 20% and a coating thickness of about 20 μm.

### 3. Determination of LiDAR Reflectivity

To determine the LiDAR reflectivity of pigments (C1) and (C2), coatings were prepared and applied as described for the determination of the masstone color of the pigment(s) (C1) and (C2). Subsequently, a clearcoat layer (approx. 50 μm dry film thickness) formed from a polyol and an isocyanate hardener (ProGloss) containing UV stabilizers was applied and cured.

LiDAR measurements on the multilayer coatings at different angles were carried out using a Velodyne VLP-16 instrument (905 nm) from Velodyne at 1 m distance.

### 4. Determination of the Flop Index

The flop index was calculated according the following formula:

$$Flop index = \frac{2.69 {( {L}_{15 °}^{*} - {L}_{110 °}^{*} )}^{1.11}}{{( {L}_{45 °}^{*} )}^{0.86}}$$

wherein L* was measured using the BYK Mac i instrument from Byk Gardner. The flop was determined on the multilayer system as described above.

### Working Examples and Comparative Examples

Measurements of the layer properties were carried out on a multilayer coating comprising, on a pre-treated steel-panel, a cathodic electrodeposition coating layer using Cathoguard 800, a grey primer layer (L*=65) formed from an aqueous primer composition containing an acrylic resin/melamine formaldehyde system (18 to 20 μm dry film thickness), an inventive or comparative basecoat film formed from an inventive or comparative basecoat composition and a clearcoat film (approx. 50 μm dry film thickness) formed from a polyol and an isocyanate hardener (ProGloss) containing UV stabilizers.

The clearcoat layer as used in the is a transparent layer and is also transparent to IR radiation. The basecoat contains aluminum flakes (i.e., platelet-shaped aluminum pigments), which gives it a distinct color and feel. However, the sparkling effect provided by the aluminum, unfortunately, results in low reflectivity at off-specular angle such as angle of incidence (AOI) 45° for the comparative formulations.

A common basecoat starting formulation is prepared as shown in Table 1 below (all parts by weight).

TABLE 1
Contents of the basecoat starting formulation

| | | Basecoat |
|---|---|---|
| | | starting |
| | Ingredients | formulation |
| 1 | synthetic layered silicate thickening agent | 0.81 |
| | incorporating an inorganic polyphosphate peptiser | |
| 2 | propylene started polypropylene oxide (Mₙ ≈ 1,000) | 0.77 |
| 3 | tetramethyl decin diol (52 wt.-% in 2-butoxyethanol)/ | 0.66 |
| | wetting agent | |
| 4 | IPDI-based polyurethane (solids: 27 wt.-%); acid | 23.11 |
| | number 10 mg OH/g (A1) | |
| 5 | 2-ethylhexanol | 3.10 |
| 6 | polyester (solids: 60 wt.-%); acid number 32 mg | 0.39 |
| | KOH/g; M_{w} 21,000-36,000 (A1) | |
| 7 | highly alkylated, mixed ether (methyl/n-butyl) | 4.48 |
| | melamine crosslinker (solids: ≥97 wt.-%) (A2) | |
| 8 | Butyl-Cellosolve | 0.73 |
| 9 | dimethyl ethanolamine | 0.06 |
| 10 | TMXDI-based polyurethane (solids 35.5 wt.-%); | 6.66 |
| | hydroxyl number 109 mg OH/g; acid number 33.5 | |
| | mg OH/g (A1) | |
| 11 | ethylene glycol monobutyl ether | 1.39 |
| 12 | amine-neutralized p-toluenesulfonic acid catalyst | 0.78 |
| 13 | non-ionic medium pseudoplastic rheology modifying | 0.11 |
| | polyurethane emulsion (solids: 40 wt. % in | |
| | water/butyldiglycol) (A1) | |
| 14 | acrylic-copolymer thickener (solids: 30 wt.-% in | 0.31 |
| | water) | |
| 15 | water, deionized | 34.83 |

Different types of aluminum (CE-1 to CE-9) are added at 0.18=(B)/(A1+A2) weight ratio until hiding is achieved. CE-1 to CE-10 in Table 2 below show the LiDAR activity of comparative basecoats containing different types of aluminum (CE-1 to CE-9) and a white reference (permaflact white from Labsphere) (CE-10).

TABLE 2
Comparison of LiDAR and Flop index for comparative basecoats

| Comparative | | Flop | LIDAR at | LIDAR at |
|---|---|---|---|---|
| Examples | | Index | AOI 45° | AOI 60° |
| CE-1 | STAPA ® Hydrolan 161 | 12 | 4.15 | 2.20 |
| CE-2 | STAPA ® Hydrolan 2153 | 13.8 | 3.65 | 2.05 |
| CE-3 | STAPA ® Hydrolan 2156 | 10.8 | 4.75 | 2.21 |
| CE-4 | STAPA ® Hydrolan 8154 | 11.50 | 4.35 | 2.00 |
| CE-5 | STAPA ® Hydrolan 9160 | 6.80 | 8.90 | 3.00 |
| CE-6 | EMERALD EX4670 | 11.00 | 5.67 | 2.00 |
| CE-7 | TCR 3130 from Toyo | 12.27 | 4.00 | 1.95 |
| | Aluminium K.K. | | | |
| CE-8 | STAPA ® NDF 170 | 13.83 | 4.25 | 2.20 |
| CE-9 | STAPA ® NDF 340 | 17.14 | 3.00 | 2.05 |
| CE-10 | White reference | — | 83.0 | 58.4 |

From these different comparative examples (CE-1 to CE-10) it can be seen that for a flop index above 10, LiDAR reflection intensities are far below 10%.

For further inventive and comparative examples a basecoat starting formulation of Table 1 is used. This formulation is supplemented with the effect pigments and pigment mixtures as lined out in Table 3 to form inventive and comparative basecoat compositions. In this invention, high flop index is achieved by tinting with two IR reflective pigments ((C1) and (C2)).

In Table 3, pigments used are Tipaque PFR404 (Rutile type TiO₂) as (C2), Altiris 550 (Rutile type TiO₂) as (C2), Tipaque black SG103 (Calcium Manganese Titanium Oxide Black Pigment) from Ishihara Sangyo Kaisha Ltd, Japan as (C1) and Sicopal Black L0095 from BASF as (C1). Further, non-inventive pigments TiO₂-R960 as a white pigment and Carbon Black (Monarch 1400) as a black pigment were employed. The pigments (C1) and (C2) as well as the non-inventive pigments were employed in form of pigment pastes, which were prepared by vibroshaking. The ingredients in each pigment paste were: 30 parts by weight of the respective solid pigment, 15 parts by weight of water, 2 parts by weight of Butyl-Cellosolve, 39.2 parts by weight of a polyurethane grinding resin, 4.8 parts by weight of Pluracol 1010 Polyol and 9 parts by weight of Byk 184.

Comparative examples CE-11 and CE-12 as well as inventive examples (E-1 to E-3) are shown in Table 3. Hydrolan 2153 is added to basecoat starting formulation to have a weight ratio of 0.18=(B+C1+C2)/(A1+A2) under hiding. Tints containing PFR404 and SG103 are added in different amounts to get E-1, E-2 and E-3. All amounts are parts by weight.

TABLE 3
Comparative Example CE-11 and inventive
Examples E-1, E-2 and E-3

| | CE-11 | CE-12 | E-1 | E-2 | E-3 |
|---|---|---|---|---|---|
| Basecoat starting | 78.19 | 78.19 | 78.19 | 78.19 | 78.19 |
| formulation | | | | | |
| Hydrolan 2153 (B) | 3.10 | — | 3.10 | 3.10 | 3.10 |
| Hydrolan 2156 (B) | — | 3.35 | — | — | — |
| Hydrolan 9160 (B) | — | 2.25 | — | — | — |
| TiO₂ -R960 | 0.25 | — | — | — | — |
| Tipaque PFR404 (C2) | — | — | — | — | 0.77 |
| Altiris 550 (C2) | — | — | 0.396 | 0.396 | — |
| Sicopal Black L0095 | — | — | — | 0.024 | — |
| (C1) | | | | | |
| Tipaque Black SG103 | — | — | 0.03 | — | 0.08 |
| (C1) | | | | | |
| Carbon Black | 0.01 | — | — | — | — |
| (Monarch 1400) | | | | | |
| Flop Index | 9.59 | 9.50 | 9.75 | 10.63 | 9.40 |
| LiDAR at 0° | 100.00 | 100.00 | 100.00 | 100.00 | 100.00 |
| LiDAR at 45° | 8.44 | 6.25 | 11.2 | 11.0 | 11.0 |
| LiDAR at 60° | 4.0 | 2.85 | 8.4 | 8.2 | 8.4 |

Hydrolan 2153 was also used in CE-2, without tinting. As can be seen from the E-1, E-2 and E-3, the LiDAR reflectivity at 45° AOI is more than two times up to three times increased in LiDAR activity for aluminum still having a flop index above 9 up to 12.5.

Also, as a comparative example tinting with TiO₂ (TI-PURE R-960) and Carbon Black (Monarch 1400) is shown. In this case, LiDAR activity is just 8.44% for a flop index of about 9.6. Tinting with the (C1)/(C2) system on the other hand gives up to 11% for a similar flop index of 9.4.

Furthermore, it was surprising that a particularly low amount of the dark non-carbon black pigment (C1) and the rather high weight ratio of (C2) to (C1) leads to the desired effect to obtain a coating having a high LiDAR at an angle of incidence of 45°, while still possessing a high flop index. Thus, in the present invention, the pigment mixture of (C1) with (C2) acts as a tinting mixture rather than providing a high hiding power.

Further examples according to the invention, using as (C2) Altris 550 (E-4) and Altris 800 (E-5), respectively, both in an amount of approx. 0.5 wt.-% based on the total weight of the coating composition, together, in both cases, with about 0.025 wt.-% of Tipaque Black SG103 (C1), based on the total weight of the coating composition, show a flop index above 9.7 as well as LiDAR reflectance at 45° AOI above 10. The base coat starting formulation is essentially the one of Table 1. This clearly shows that white LiDAR reflective pigments other than Tipaque PFR 404 also lead to excellent effects.

In a further example according to the invention, using as (C2) Altris 550 (E-6) in an amount of approx. 0.5 wt.-% based on the total weight of the coating composition, together, with about 0.03 wt.-% of Sicopal L0095 (C1), based on the total weight of the coating composition, flop index of 10.6 as well as LiDAR at 45° AOI were above 10. The base coat starting formulation is essentially the one of Table 1. This clearly shows that white LiDAR reflective pigments other such as Atris 550 also lead to excellent effects with black pigments such as Sicopal L 0095, differing from Tipaque Black SG103.

1. A basecoat composition, comprising
(A) at least one film-forming polymer (A1), and if (A1) is externally crosslinkable, at least one crosslinking agent (A2);
(B) at least one type of metal effect pigment (B);
(C) a pigment mixture (C), comprising
at least one non-carbon-black LiDAR reflecting pigment (C1) or combination of non-carbon-black LiDAR reflecting pigments (C1), wherein the pigment or combination of pigments has a masstone color with full hiding according to CIELAB system at 45° the values of L*<17, a*>−4 and <9, and b*>−4 and <9, and
at least one white LiDAR reflecting pigment (C2) or combination of white LiDAR reflecting pigments (C2), wherein the pigment or combination of pigments has a masstone color with full hiding according to CIELAB system 45° the values of L*>85, a*>−2 and <2, and b*>0 and <6, (C2); and
(D) water and/or one or more organic solvents as component (D),
wherein
(C1) is present in a range from 0.005 to 2.0 wt.-% based on the total weight of the composition, and
(C2) is present in a range from 0.20 to 10.0 wt.-% based on the total weight of the composition.

2. The basecoat composition according to claim 1, wherein the film-forming polymer (A1) is selected from the group of polymers consisting of polyurethanes, polyureas, polyesters, polyamides, poly(meth)acrylates and copolymers of the structural units of said polymers; and, if (A1) is externally crosslinkable, (A2) is selected from the group of crosslinking agents consisting of aminoplast resins, blocked polyisocyanates and free polyisocyanates.

3. The basecoat composition according to claim 1, wherein the at least one metal effect pigment (B) is platelet-shaped and possesses a median particle size (D50) in the range of 5 μm to 100 μm as determined by laser granulometry according to ISO 13320-1.

4. The basecoat composition according to claim 1, wherein the at least one metal effect pigment (B) is comprised in the basecoat composition in an amount from 1 to 10 wt.-% based on the total weight of the basecoat composition.

5. The basecoat composition according to claim 1, wherein the at least one metal effect pigment (B) is aluminum or an alloy thereof.

6. The basecoat composition according to claim 1, wherein the non-carbon-black LiDAR reflecting pigment (C1) is selected from the group consisting of iron/chromium oxide compounds, manganese ferrite black oxide, calcium manganese titanium oxide, and chromium-free compounds; and/or the white LiDAR reflecting pigment (C2) is selected from the group consisting of titanium/aluminum/silicon oxide-based pigments and rod-like aluminum-doped titanium dioxide pigments.

7. The basecoat composition according to claim 1, wherein the weight ratio of (C2) to (C1) is from 10 to 30.

8. The basecoat composition according to claim 1, wherein the solids content based on the total weight of the basecoat composition is in the range from 5 to 85 wt.-%.

9. The basecoat composition according to claim 1, wherein the basecoat composition contains one or more further components (E) which are different from each of components (A1), (A2), (B), (C) and (D) and which are contained in an amount of 0.01 to 25 wt.-%, based on the total weight of the basecoat composition.

10. A method of forming a coating film at least partially onto at least one surface of a substrate, wherein said method comprises at least step (a), namely
(a) applying the basecoat composition according to claim 1 at least partially onto at least one surface of an optionally pre-coated substrate to form a coating film on the surface of the substrate.

11. A method of forming a coating at least partially onto at least one surface of a substrate, wherein said method comprises the at least step (a) according to claim 10 and at least step (b), namely
(b) curing the coating film obtained after performing of step (a) to form a coating on the surface of the substrate.

12. A coating film obtained from the coating composition according to claim 1.

13. An at least partially coated substrate obtained by the method according to claim 11.

14. The at least partially coated substrate of claim 13, wherein the substrate prior to performing the coating method is not or essentially not NIR-reflective.

15. A method of using the coating film of claim 12, the method comprising using the coating film in LiDAR visibility applications concerning vehicles and parts thereof.

16. A coating film obtained by the method of claim 10.

17. A coating obtained by the coating composition according to claim 1.

18. A coating obtained by the method of claim 11.

19. A method of using the at least partially coated substrate of claim 13 and/or an object produced from the at least partially coated substrate, the method comprising using the at least partially coated substrate and/or the object produced from the at least partially coated substrate in LiDAR visibility applications concerning vehicles and parts thereof.
